(19) United States
(12) Patent Application Publication
(10) Pub. No.: US 2014/0112350 A1
(43) Pub. Date: Apr. 24, 2014

(54) APPARATUS AND METHOD FOR CONTROLLING UNI PATH

(71) Applicant: Electronics and Telecommunications Research Institute, Daejeon-si (KR)

(72) Inventors: Tae-Hyun KWON, Gyeongsangbuk-do (KR); Sun-Me KIM, Daejeon-si (KR)

(73) Assignee: Electronics and Telecommunications Research Institute, Daejeon-si (KR)

(21) Appl. No.: 14/056,460

(22) Filed: Oct. 17, 2013

(30) Foreign Application Priority Data
Oct. 19, 2012 (KR) 10-2012-0116918
Oct. 15, 2013 (KR) 10-2013-0122697

(51) Int. Cl. H04L 12/723

(52) U.S. Cl. CPC H04L 45/50
USPC 370/437

(57) ABSTRACT

A user network interface (UNI) path setting method includes advertising an attribute and state information of a TNA interface, and updating a database using information collected through the advertising, computing a path to a destination TNA address from a source TNA address satisfying UNI path setting parameter information included in a path message in consideration of an attribute and state information of the updated TNA interface/link when receiving a path setting request message from an operator, transmitting a path message to a destination through a network based on the computed path, and transmitting a reservation (RESV) message for UNI path generation to a source through the network when normally receiving, by the destination, the path message.

### CROSS-REFERENCE TO RELATED APPLICATION

This application claims priority from Korean Patent Applications No. 10-2012-0116918, filed on Oct. 19, 2012, and No. 10-2013-0122697, filed on Oct. 15, 2013, in the Korean Intellectual Property Office, the disclosure of which is incorporated herein by reference in its entirety.

### BACKGROUND

1. Field of the Invention

The present invention relates to user network interface (UNI) path setting technologies using a generalized multi-protocol label switching (GMPLS) control plane, and more particularly, to a UNI path control method and apparatus which may ensure end-to-end service quality.

2. Discussion of Related Art

As abilities of a transport network for a high-speed and large-capacity backbone have spread to a metro network and a subscriber network with the development of optical transmission technologies, there has arisen a demand for an intelligent transport network that can rapidly provide new services such as a transmission line and the like to subscribers. Thus, an automated transport network control plane structure through protocol introduction such as routing, signaling, and the like which are verified in a data network has been recommended by the International Telecommunication Union-Telecommunication Standardization Sector (ITU-T), and a generalized multi-protocol label switching (GMPLS) has been adopted as a protocol. In recent years, an automated control plane has been required even in a transport network such as provider backbone bridge traffic engineering (PBB-TE), multi-protocol label switching-transport profile (MPLS-TP), and the like.

As examples of a path control method which is defined in the automated transport network control plane structure recommended by the ITU-T, that is, an automatically switched optical network (ASON), a permanent connection (hereinafter, referred to as “PC”) method using a management plane, a soft-permanent connection (hereinafter, referred to as “SPC”) method using a management plane and a control plane (hereinafter, referred to “GMPLS control plane”), a switched connection (hereinafter, referred to “SC”) method using only the GMPLS control plane may be used.

Here, the GMPLS control plane includes functions such as a path computation element (CSPE; constrained shortest path first or PCE), signaling, routing, a link management protocol (LMP), and the like. The signaling function includes a signaling protocol (for example, RSVP-TE), and the routing function includes a routing protocol (for example, OSPF-TE). When a PCE is used as the path computation element, a path computation client (PCC) that requests path computation from the PCE and receives the response is further included, and the PCC is separately present to be included in the signaling function.

The PCE is originally included as a functional block included in a head-end node (HEN) of an MPLS/GMPLS network, that is, a label edge router (LER) node, or a functional block of a network control management system (for example, NMS and path control management system). In recent years, the PCE has been separated in the form of an external PCE to be operated due to causes such as a reduction in a load of a network node, additional function expansion, and the like, and may be operated as a centralized PCE, a distributed PCE, or various types of PCEs based on reference.

The PCE computes an optimized path based on a traffic engineering database (TED) in accordance with a request of the PCC. That is, the PCE uses a network topology included in the TED and resource information (information required for path computation such as TE topology information, state information of a TE link, a total bandwidth, a currently used bandwidth, an available bandwidth, color information, metric, and the like) at the time of path computation. The PCE and the PCC generally communicate using a path computation element protocol (PCEP).

Meanwhile, in the Optical Internetworking Forum (OIF), a user network interface (UNI) is defined as a service control interface between a UNI-client (UNI-C) side and a UNI-network (UNI-N) side, the UNI-C is defined as a logical entity for performing or processing UNI signaling on a client side, and the UNI-N is defined as a logical entity for performing or processing UNI signaling on a network side. A transport network assigned (TNA) address is an address allocated to a data bearing link (interface/port) that connects the UNI-N and the UNI-C for identifying a client (subscriber or subscriber equipment) in a transport network, that is, allocated to a UNI link (interface/port), and is defined in the OIF.

A UNI path is a path that is set end-to-end (UNI-C to UNI-C or UNI-N to UNI-N) based on a TNA address of a terminal end, and in conventional UNI path setting technologies, path setting is performed based on a path computation result ranged up to a destination UNI-N node in consideration of only a destination TNA address, at the time of path computation for UNI path setting in an HEN of a network, that is, an ingress UNI-N, and therefore service quality cannot be ensured with respect to the UNI link (link between UNI-C and UNI-N).

That is, in the conventional technologies, only the TNA address is advertised within a transport network through a routing protocol, which does not consider resource and state information of a UNI link (interface) associated with the TNA address at the time of path computation, and therefore the conventional UNI path control technologies cannot ensure end-to-end service quality (UNI-C to UNI-C or UNI-N to UNI-N).

### SUMMARY OF THE INVENTION

The present invention is directed to a user network interface (UNI) path control method and apparatus which may ensure end-to-end service quality through path computation in consideration of resource and state information of a UNI interface (or port) associated with a transport network assigned (TNA) address.

According to an aspect of the present invention, there is provided a user network interface (UNI) path setting method by UNIs in a network in which a predetermined transport network assigned (TNA) address is used between a client and a UNI-network (UNI-N), including: advertising, by the UNI-Ns, an attribute and state information of a TNA interface, and updating a database using information collected through the advertising; computing, by the UNI-N, a path to a destination TNA address from a source TNA address satisfying UNI path setting parameter information included in a path message in consideration of an attribute and state information of the updated TNA interface/link when receiving a path setting request message from an operator; and setting a UNI path in accordance with the computed path.

According to another aspect of the present invention, there is provided a UNI path setting apparatus in a network in which a predetermined TNA address is used between a client and a UNI-N, including: a routing unit configured to advertise an attribute and state information of a TNA interface and update a database using information collected through the advertisement; a path computation unit configured to compute a path to a destination TNA address from a source TNA address satisfying UNI path setting parameter information included in a path message in consideration of an attribute and state information of the updated TNA interface/link when receiving a path setting request message from an operator; and a signaling unit configured to transmit the computed path information to the network.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating a user network interface (UNI), a UNI-client (UNI-C), a UNI-network (UNI-N), and a transport network assigned (TNA) address which are defined in the Optical Internetworking Forum (OIF);

FIG. 2 is a diagram illustrating an example of a network state to which a TNA address is allocated between a UNI-C and a UNI-N;

FIG. 3 is a diagram illustrating a configuration of a network according to an embodiment of the present invention;

FIG. 4 is a functional block diagram illustrating a generalized multi-protocol label switching (GMPLS) control plane according to an embodiment of the present invention;

FIG. 5 is a flowchart illustrating a procedure for setting a UNI path in an IS-UNI method (SC method) according to an embodiment of the present invention;

FIG. 6 is a flowchart illustrating a procedure for setting a UNI path in an IS-SPC method (SPC method) according to an embodiment of the present invention;

FIG. 7 is a flowchart illustrating path computation according to an embodiment of the present invention; and

FIG. 8 is a flowchart illustrating a path setting procedure in case of including a CAC function in a source UNI-C according to an embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

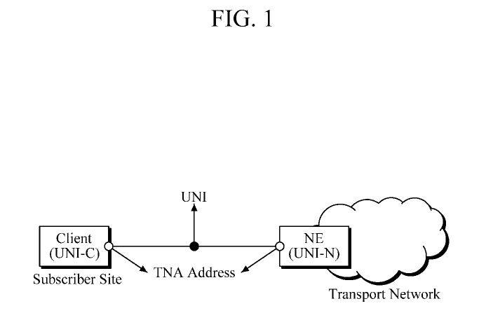

FIG. 1 is a diagram illustrating a user network interface (UNI), a UNI-client (UNI-C), a UNI-network (UNI-N), and a transport network assigned (TNA) address which are defined in the Optical Internetworking Forum (OIF).

Referring to FIG. 1, in the Optical Internetworking Forum (OIF), the UNI is defined as a service control interface between the UNI-C and the UNI-N.

The UNI-C is a logical functional entity for performing or processing UNI signaling on a client side, and the UNI-N is a logical functional entity for performing or processing UNI signaling on a network side.

The TNA address is an address allocated to a data bearing link (interface/port) that connects the UNI-N and the UNI-C in order to identify a client (subscriber or subscriber equipment) in a transport network, that is, allocated to a UNI link (interface/port), which is defined in the OIF. The TNA address has the same meaning as a TNA name or a UNI transport identifier defined in the ITU-T.

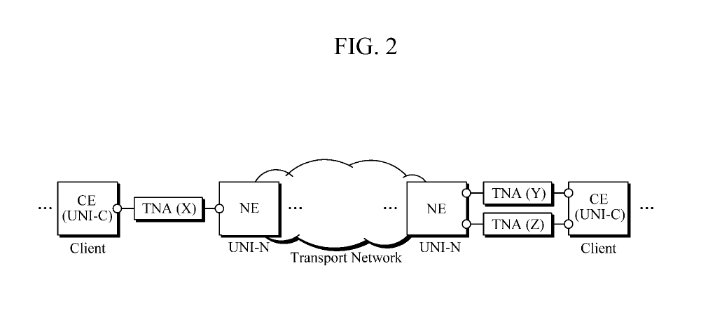

A plurality of TNA addresses may be allocated to a single node, and in FIG. 2, an example of a network state in which two TNA addresses are allocated between the UNI-C and the UNI-N is illustrated. Such allocated TNA addresses are advertised within a transport network through a routing protocol.

A UNI path is a path that is set end-to-end (UNI-C to UNI-C or UNI-N to UNI-N) based on a TNA address at a terminal end, and uses UNI signaling (GMPLS signaling). A UNI path control method using UNI signaling may be divided again into an IS-SPC method (SPC method) and IS-UNI method (SC method) in accordance with whether a UNI signaling processing function (UNI-C function) exists or is used in subscriber equipment (for example: router, switch, or the like) of a client, that is, a terminal end.

However, in such conventional UNI path setting technology, path setting is performed based on a path computation result ranged up to a destination UNI-N node in consideration of only a destination TNA address at the time of path computation for UNI path setting in a head-end node (HEN) of a network, that is, an ingress UNI-N, and therefore service quality cannot be ensured with respect to the UNI link (link between UNI-C and UNI-N). That is, in the conventional technologies, only the TNA address is advertised within a transport network through a routing protocol, and the advertisement of the TNA address does not consider resource and state information of the UNI link (interface) associated with the TNA address at the time of path computation. Thus, in the conventional UNI path control technologies, end-to-end service quality (UNI-C to UNI-C or UNI-N to UNI-N) cannot be ensured.

Therefore, in order to overcome such problems of the conventional technologies, according to the present invention, there is provided a UNI path control method and apparatus in which the end-to-end service quality can be ensured through the path computation in consideration of the resource and state information of the UNI interface (or port) associated with the TNA address.

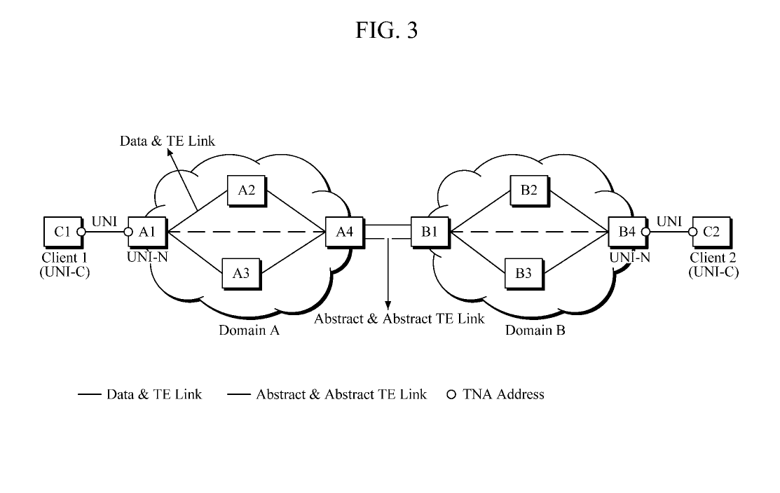

FIG. 3 is a diagram illustrating a configuration of a network according to an embodiment of the present invention.

Referring to FIG. 3, nodes A1 to A4 and B1 to B4 which constitute a domain include generalized multi-protocol label switching (GMPLS) control plane functions. Client nodes (clients C1 and C2) may include or not include a UNI-C function in accordance with a network configuration.

When including the UNI-C function, the client nodes (C1 and C2) may include GMPLS control plane functions or minimal functions for UNI path control. For example, the minimal functions required for the UNI path control may include a UNI signaling function (signaling unit), a path control management function (path control management unit), a function for finding a next hop in order to transmit a UNI signaling message to a next node, and the like. For example, even though the GMPLS control plane functions are included in the nodes, a routing protocol between the UNI-C and the UNI-N and a link management protocol (LMP) are not generally operated, and a path computation function such as CSPF is not included, either.

For the purpose of path computation based on the TNA address, that is, reachability to a destination TNA address, an abstract link and abstract TE links are configured or included between A1 and A4, A4 and B1, and B1 and B4. In order to advertise the TNA address and the abstract TE links of each domain (domain A and domain B) between the domains, an external network-network interface (E-NNI) routing unit (for example, OSPF-TE routing protocol) is operated in the A1 and B4, and an internal network-network interface (I-NNI) routing unit (for example, OSPF-TE routing protocol) is operated in the nodes (A1 to A4 and B1 to B4) constituting the domain in order to advertise the TE links within the domain. This is identified by an instance ID. Here, two domains are illustrated, but this is merely described for convenience of description, and thus the present invention is not limited thereto.

The UNI path is a path which is set end-to-end (UNI-C to UNI-C or UNI-N to UNI-N) based on the TNA address at a terminal end, and uses UNI signaling (GMPLS signaling). The UNI path control method using UNI signaling (for example, RSVP-TE) may be divided again into an IS-SPC method (SPC method) and an IS-UNI method (SC method) in accordance with whether a UNI signaling processing function (UNI-C function) exists or is used in subscriber equipment (for example: router, switch, or the like) of a client, that is, a terminal end.

The IS-UNI method is a method that is used in a case in which the UNI-C function exists and is used in clients (see, C1 and C2 in FIG. 3), that is, subscriber equipment (for example: router, switch, and the like) of a terminal end. On the other hand, the IS-SPC method is a method that is used in a case in which the UNI-C function does not exist in clients (see, C1 and C2 in FIG. 3), that is, the subscriber equipment of the terminal end or a case in which the UNI-C function is not used even though it exists.

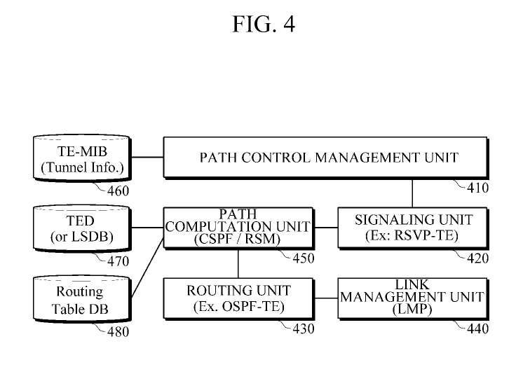

FIG. 4 is a functional block diagram illustrating a GMPLS control plane according to an embodiment of the present invention.

Referring to FIG. 4, the GMPLS control plane includes a path control management unit 410 for performing a path management function, a signaling unit 420 for performing a signaling function, a routing unit 430 for performing a routing function, a link management unit 440, a path computation unit 450 (CSPF; constrained shortest path first), a TE-MIB 460 that is a database, a TED 470 (or LSDB), and a routing table DB 480.

The UNI path is managed by the path control management unit 410. The path control management unit 410 may receive a UNI path control command from an operator (CLI, EMS/NMS, or the like) in accordance with the UNI path control method, or receive a UNI path control result from the signaling unit 420 to update related tables 460.

The signaling unit 420 may set or release a UNI path using a signaling protocol (RSVP-TE), receive UNI path setting and releasing commands from the path control management unit 410 in accordance with the UNI path control method, and receive a UNI path setting and releasing message from the signaling unit 420 of another node.

When a route selection manager (RSM) of the path computation unit 450 receives a next hop routing (NHR) query request message from the signaling unit 420, the signaling protocol may find a node of a next hop using the routing table DB 480 in order to transmit the signaling message in a signaling process. In addition, when receiving the NHR query request message from the signaling unit 420, the signaling protocol may internally request path computation from the CSPF 450.

The CSPF 450 of the path computation unit may perform path computation using a TED (or link state database (LSDB)). Here, a PCE may be used instead of the CSPF. The PCE may exist inside or outside the node. When the PCE exists outside the node, the PCE and the TED may exist together.

The TED 470 is provided to the CSPF by the routing unit 430, and the routing unit 430 includes an OSPF-TE routing protocol. The routing table DB 480 is provided to an RSM through the routing unit 430 and an interface management function. In particular, the TED 470 includes a network topology and resource information required for path computation. Here, the routing unit 430 may respectively exist so as to have a function for E-NNI routing and a function for I-NNI routing within a domain. This is identified by an instance ID.

The CSPF of the path computation unit 450 may also respectively exist so as to have a function for E-NNI path computation and a function for I-NNI path computation, or exist in an integrated form. In addition, the TED 470 may respectively exist as E-NNI TED and I-NNI TED, or exist in an integrated form. The link management unit 440 includes a link management protocol (LMP).

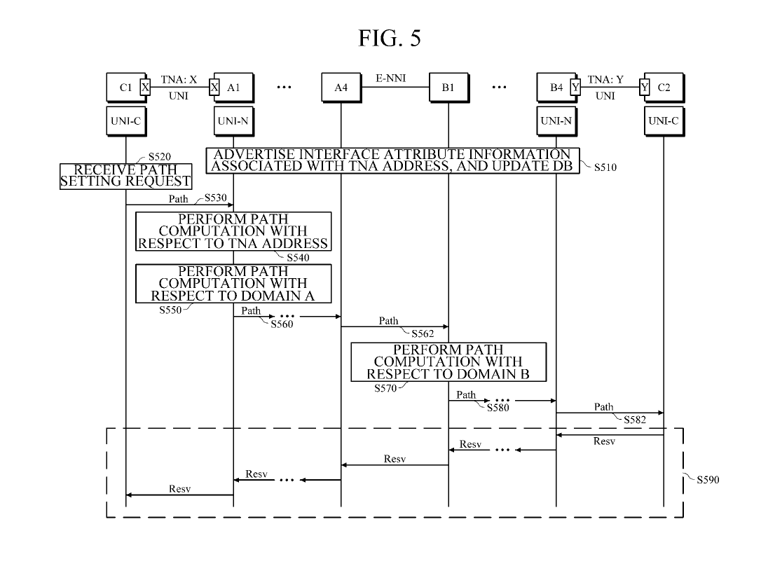

FIG. 5 is a flowchart illustrating a procedure for setting a UNI path in an IS-UNI method (SC method) according to an embodiment of the present invention.

As described above, the IS-UNI method (SC method) is a method that is used in a case in which a UNI-C function exists and is used in clients, that is, subscriber equipment (for example, router, switch, and the like) of a terminal end. Referring to FIG. 5, for UNI path setting, a predetermined TNA address between the UNI-C and the UNI-N is used as described above.

In general, in order to set a UNI path, path computation is performed twice in an HEN of a network, that is, an ingress UNI-N.

The first path computation is for ascertaining reachability from a source TNA address to a destination TNA address based on the source and destination TNA addresses included in a UNI path setting request message, and the second path computation is for computing a path from an ingress node of a domain to an egress node thereof based on a path computation result based on the TNA address.

In FIG. 5, there are differences in operations S510 and S540 between the conventional technologies and the present invention.

Only the TNA address is considered in the conventional technologies, but in operation S540 according to the present invention, path computation satisfying information included in a UNI path setting parameter may be performed in consideration of the TNA address and an attribute and state information of an interface/link with respect to the TNA address. For this, operation S510 should be preceded.

That is, in the conventional technologies, only the TNA address is advertised and the advertised TNA address is updated to the TED, but in operation S510 according to the present invention, the attribute and state information of the TNA interface (or port) are advertised through the routing unit 430 of the GMPLS control plane of A1 and B4, and the advertised information is updated to the TED.

Here, the attribute and state information of the TNA interface (or port) includes a node ID, a TNA address type, a TNA address, and interface (or port) attribute (interface ID, bandwidth, switching type, encoding, and the like) and state information associated with the TNA address. The bandwidth information includes a maximum LSP bandwidth, a minimum LSP bandwidth, and the like. Such information may be included in an opaque area link-state advertisement (LSA) of the routing protocol as a TLV and sub-TLVs to be advertised. In addition, in this regard, in the present invention, a threshold value with respect to an attribute and state information advertisement of the interface/link with respect to the TNA address may be set and adjusted.

In FIG. 5, a procedure for setting a UNI path from a TNA X (C1) to a TNA Y (C2) using the IS-UNI method (SC method) is illustrated, and differences between the procedure of the present invention and the conventional technologies will be herein concentratedly described.

In operation S510, an E-NNI routing unit of the routing unit 430 of the GMPLS control plane of A1 and B3 includes and advertises interface attribute information associated with a TNA address when advertising the TNA address in addition to abstract TE link advertisement, and updates a TDB based on the advertised information.

In operation S520, a UNI path setting request is received from an operator of the path control management unit 410 of FIG. 4. The operator may use CLI, EMS/NMS, and the like. The UNI path setting request includes parameters (source TNA address and type, destination TNA address and type, QoS parameter, and the like) for UNI path setting.

In operation S530, the path control management unit 410 that has received the UNI path setting request requests the UNI path setting from the signaling unit 420. The signaling unit 420 transmits a path message to a next hop A1 after next hop routing (NHR) query.

In operation S540, the signaling unit 420 that has received the path message in A1 requests NHR query and path computation from the CSPF/RTM 450 based on UNI path setting parameter information (source TNA address and type, destination TNA address and type, QoS parameter, and the like) included in the path message. The CSPF/RTM 450 that has received this performs path computation based on the TNA address, that is, path computation at an abstract TE link level in order to ascertain whether there exists a path reachable from the source TNA address (X) to the destination TNA address (Y), that is, to ascertain reachability of the destination TNA address. In the present invention, path computation satisfying information included in the path setting parameter is performed in consideration of the attribute and state information of the interface/link with respect to the source and destination TNA addresses. The path computation result based on the TNA address includes path information composed of a node from the source TNA address (X) to the destination TNA address (Y) and abstract TE link IDs.

In operation S550, path computation with respect to a local domain A is performed based on the path computation result based on the TNA address. That is, TE link-based path computation satisfying information (for example; bandwidth) included in a path setting parameter from an ingress node A1 of the local domain A to an egress node A4 thereof, that is, a border node is performed. The path computation result with respect to the local domain A includes path information composed of a node from the ingress node A1 to the egress node A4 and the TE link IDs. The TNA address-based path computation result and the path computation result of the local domain A are merged and updated. Specifically, a part of the TNA address-based path computation result (a part composed of a node of the local domain A and abstract TE link IDs) included in the local domain A from the TNA address-based path computation result is updated as the TE link-based path computation result of the local domain A. The path computation result is transmitted to the signaling unit 420.

In operations S560 and S562, a path message is transmitted based on a computed explicit route.

In operation S570, the signaling unit 420 that has received the path message in the B1 performs path computation with respect to the local domain B based on the explicit route included in the path message and UNI path setting parameter information, that is, path computation from an ingress node of the domain B to an egress node (border node) thereof. Next, a path part of the local domain B composed of a node and abstract TE IDs in the explicit path is updated as a path computation result based on the TE link.

In operations S580 and S582, a path message is transmitted based on the computed explicit route.

In operation S590, by transmitting an Resv message in the reverse direction, a UNI path is set. Here, setting an RSVP-TE-based LSP using the explicit route information is a unique function of RSVP-TE, and thus the above-described specific descriptions will be omitted.

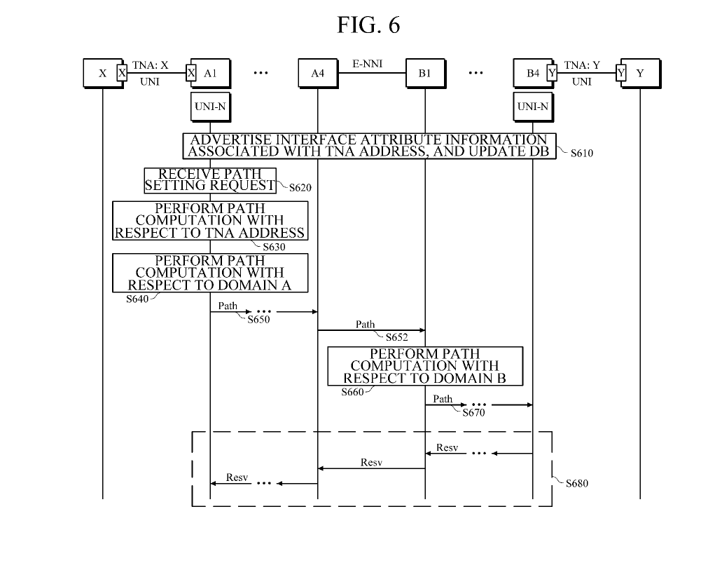

FIG. 6 is a flowchart illustrating a procedure for setting a UNI path in an IS-SPC method (SPC method) according to an embodiment of the present invention.

As described above, the IS-SPC method (SPC method) is a method that is used in a case in which a UNI-C function does not exist in clients, that is, subscriber equipment of a terminal end or the UNI-C function is not used even though it exists. As a difference from FIG. 5, a procedure for setting a UNI path from TNA X (A1) to TNA Y (B4) using the IS-SPC method (SPC method) is illustrated.

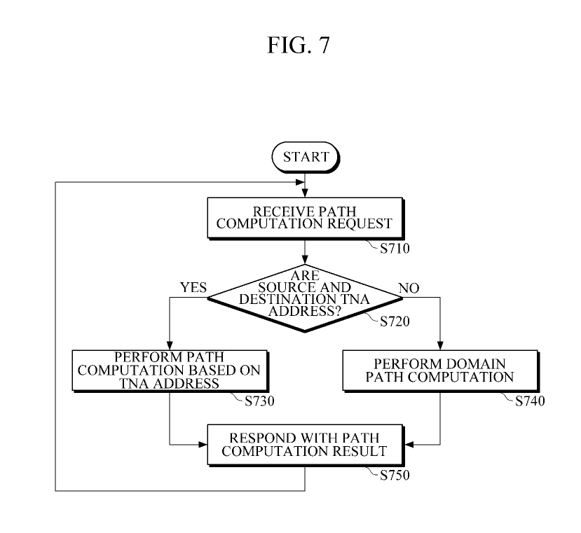

FIG. 7 is a flowchart illustrating path computation according to an embodiment of the present invention.

In operation S710, when receiving a path computation request, whether source and destination addresses are a TNA address is determined.

In operation S730, when the source and destination addresses are the TNA address in operation S710, path computation satisfying information included in a path setting parameter is performed in consideration of an attribute and state information of an interface (or port) with respect to the source and destination TNA addresses.

Meanwhile, in operation S740, when the source and destination addresses are not the TNA address in operation S710, path computation of a domain is performed. Next, in operation S750, a path computation result is responded.

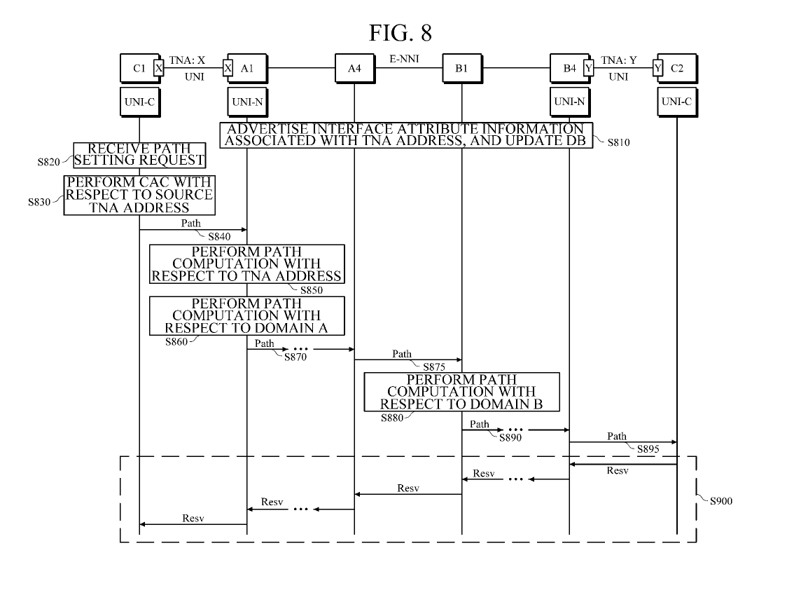

FIG. 8 is a flowchart illustrating a path setting procedure in case of including a CAC function in a source UNI-C according to an embodiment of the present invention.

Referring to FIG. 8, a CAC function with respect to a source TNA address is performed in a source UNI-C(X). The CAC function is performed based on an attribute and state information of an interface associated with the source TNA address. For example, when an available bandwidth of the interface associated with the source TNA address satisfies a QoS parameter (bandwidth) required in a path setting parameter, a path setting request message (Path) is transmitted to a UNI-N(A1) node. On the other hand, when the available bandwidth does not satisfy the QoS parameter, a path setting failure is returned, and a procedure for the path setting failure is performed. The conventional technologies do not include the above-described function, but simply transmit the path setting request message (Path) to the UNI-N(A1) node based on the TNA address.

As described above, according to the embodiments of the present invention, errors (errors which may affect normally provided services) of a UNI path setting process which occur when a required bandwidth is not satisfied and a cranback (backtracking procedure) may be minimized, and end-to-end service quality (UNI-C to UNI-C or UNI-N to UNI-N) may be ensured through service quality guarantee in a UNI-C and UNI-N interval.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A user network interface (UNI) path setting method by UNIs in a network in which a predetermined transport network assigned (TNA) address is used between a client and a UNI-network (UNI-N), comprising:
advertising, by the UNI-Ns, an attribute and state information of a TNA interface, and updating a database using information collected through the advertising;
computing, by the UNI-N, a path from a source TNA address to a destination TNA address, in consideration of an attribute and state information of the updated TNA interface/link when receiving a path setting request message wherein the path satisfies UNI path setting parameter information included in a path message; and
setting a UNI path in accordance with the computed path.

2. The UNI path setting method of claim 1, wherein the attribute and state information of the TNA interface includes a node ID, a TNA address type, a TNA address, and an interface attribute and state information associated with the TNA address.

3. The UNI path setting method of claim 2, wherein the interface attribute includes an interface ID, a bandwidth, a switching type, and encoding information.

4. The UNI path setting method of claim 1, wherein the updating includes advertising the attribute and state information of the TNA interface through an opaque area link-state advertisement (LSA) of a routing protocol.

5. The UNI path setting method of claim 1, wherein the updating includes setting and adjusting a threshold value with respect to an attribute and state information advertisement of the interface/link with respect to the TNA address.

6. The UNI path setting method of claim 1, wherein the computing includes:
computing the path satisfying information included in a path setting parameter in consideration of an attribute and state information of an interface with respect to the source and destination TNA addresses in a case in which source and destination addresses are TNA addresses when receiving a path computation request; and
computing a path of a domain in a case in which the source and destination addresses are not the TNA addresses.

7. The UNI path setting method of claim 1, further comprising:
transmitting the path setting request message to the UNI-N when the UNI-C satisfies an attribute and state information of an interface associated with the source TNA address; and
returning a path setting failure to perform a procedure with respect to the path setting failure when the UNI-C does not satisfy the attribute and state information of the interface associated with the source TNA address.

8. A UNI path setting apparatus in a network in which a predetermined TNA address is used between a client and a UNI-N, comprising:
a routing unit configured to advertise an attribute and state information of a TNA interface and update a database using information collected through the advertisement;
a path computation unit configured to compute a path from a source TNA address to a destination TNA address, satisfying UNI path setting parameter information included in a path message in consideration of an attribute and state information of the updated TNA interface/link when receiving a path setting request message from an operator; and
a signaling unit configured to transmit the computed path information to the network.
